(19) United States
(12) Patent Application Publication
(10) Pub. No.: US 2012/0192650 A1
(43) Pub. Date: Aug. 2, 2012

(54) DETECTION SYSTEM AND SIGNAL PROCESSING METHOD THEREOF

(75) Inventors: Ming-Chia Tsai, Taipei (TW); An-Yeu Wu, Taipei (TW); Pai-Chi Li, Taipei (TW); Cheng-Zhou Chan, Taipei (TW); Yu-Hao Chen, Taipei (TW)

(73) Assignee: National Taiwan University, Taipei City (TW)

(21) Appl. No.: 13/355,476

(22) Filed: Jan. 20, 2012

(30) Foreign Application Priority Data
Jan. 27, 2011 (TW) 100103157

(51) Int. Cl. G01N 29/04; G01N 29/44

(52) U.S. Cl. 73/602

(57) ABSTRACT

A signal processing method is adapted for dealing with a plurality of vector matrixes to detect the image of a predetermined range, and the vector matrix data are generated by reflecting a plurality of ultrasonic beams in the predetermined range. The signal processing method of the present invention is that summing all vector matrix data in a predetermined time interval so as to generate a total correlation matrix. In addition, obtaining a correlation matrix through the total vector matrix multiplied by a transposed total vector matrix, and obtaining a weight value according to inversion correlation matrix. Then, a weighting operation is performed for the vector matrix data in the predetermined time interval according to the weight value, so as to obtain a weighting operation result for performing an image synthesis procedure.

### FIELD OF THE INVENTION

The present invention relates to signal processing methods, and more particularly to a signal processing method used in an ultrasonic imaging system.

### BACKGROUND OF THE INVENTION

Ultrasonic wave is usually a mechanical vibration wave generated by a piezoelectric crystal in an electric field. A mechanical vibration wave having a frequency of 20 kHz is commonly identified as an ultrasonic wave. At present, ultrasonic wave is mainly used as a tool for testing, measuring or control, such as measuring thickness, measuring distance, medical treat, medical diagnosis or ultrasonic wave imaging. In addition, ultrasonic wave can also be used for disposing material so as to change or speeding up changing some physical, chemical and biological character or state, for example, using a void effect of the ultrasonic wave in liquid for machining, cleaning, soldering, emulsifying, smashing, degassing, catalyzing chemical reaction or medical treatment.

In an ultrasonic imaging system in prior art, when a vector matrix generated by a reflected ultrasonic wave beam is received, a correction matrix can be obtained through the vector matrix multiplied by a transposed vector matrix. Then, all vector matrix data in a predetermined time interval is summed so as to generate a total correlation matrix. A weight value is obtained as a parameter of subsequent image synthesis according to an inversion operation of the total correlation matrix.

Inversion operation of the vector matrix for obtaining correction matrix is always needed after obtaining the vector matrix, thus, a process time is prolonged and operation complexity is larger. Besides, due to the total correction matrix is very large, the operation complexity can also be raised in the inversion matrix operation. Therefore, the complexity of total system can be raised.

### SUMMARY OF THE INVENTION

The present invention provides a detection system for detecting image information in a predetermined range.

The present invention also provides a signal processing method used in an ultrasonic wave imaging system for simplifying system operation.

The present invention provides a detection system, which comprises an ultrasonic module, a plurality of receiving units, a plurality of analog-digital converters, a processing module and an image synthesis unit. The ultrasonic module comprises a plurality of ultrasonic units arranged in array, and the plurality of ultrasonic units continuously emit a plurality of ultrasonic beams in a predetermined range. When the ultrasonic beams is reflected in the predetermined range and received by the plurality of receiving units, the plurality of receiving units respectively receive generate a plurality of channel signals. Each of the channel signals is converted to a digital data by a corresponding analog-digital converter, so as to generate a vector matrix data. The processing module obtains a total vector matrix data by summing the vector matrix data received in a predetermined time interval, and further obtains a correction matrix through the total vector matrix data multiplied by the transposed total vector matrix data. The processing module further performs an inversion operation of the correction matrix and obtains a weight value according to the inversion correction matrix, so that a weighting operation is performed for the vector matrix data in the predetermined time interval according to the weight value, so as to obtain a weighting operation result.

In an embodiment of the present invention, the processing module includes a weighting operation unit, a parameter operation unit and a multiplier. The weighting operation unit generates the correction matrix and the weight value according to the vector matrix data. The parameter operation unit generates a relative parameter function according to the vector matrix data. In addition, the multiplier is coupled to the weighting operation unit and the parameter operation unit, so that the weighting operation for the vector matrix data is performed through the relative parameter function multiplied by the weight value to obtain the weighting operation result.

In another aspect, the present invention also provides a signal processing method adapted for dealing with a plurality of vector matrixes to detect the image of a predetermined range, and the vector matrix data are generated by reflecting a plurality of ultrasonic beams in the predetermined range. The signal processing method of the present invention includes summing all vector matrix data in a predetermined time interval so as to generate a total correlation matrix. In addition, obtaining a correlation matrix through the total vector matrix multiplied by a transposed total vector matrix, and obtaining a weight value according to inversion correlation matrix. Then, a weighting operation is performed for the vector matrix data in the predetermined time interval according to the weight value, so as to obtain a weighting operation result for performing an image combination procedure.

In the present invention, the processing module obtains the total vector matrix, and further calculates the correction matrix and inversion correction matrix. Thus, the operation complexity of the system can be obviously simplified.

For above and another objectives, features, and advantages of the present invention being better understood and legibly, accompanying embodiments together with the drawings are particularized.

### BRIEF DESCRIPTION OF THE DRAWINGS

The present invention will become more readily apparent to those ordinarily skilled in the art after reviewing the following detailed description and accompanying drawings, in which:

FIG. 1 is a block diagram of a detection system according to a preferred embodiment of the present invention; and

FIG. 2 is a block diagram of the processing module according to a preferred embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

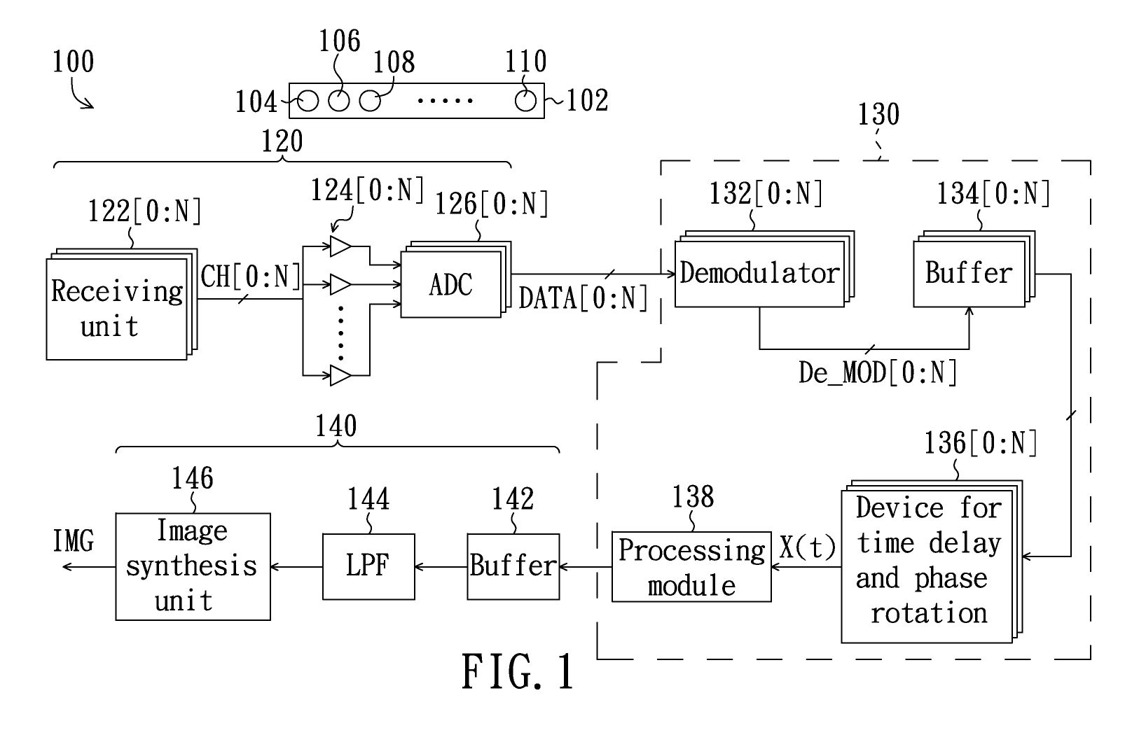

FIG. 1 shows a block diagram of a detection system according to a preferred embodiment of the present invention. Referring to FIG. 1, in the embodiment, a detection system 100 includes an ultrasonic module 102 having a number of N ultrasonic units as labeled by 104, 106, 108 and 110, and the number of N ultrasonic units is arranged in array, wherein N is a positive integer greater than or equal to 1. In the embodiment, the ultrasonic units 104, 106, 108 and 110 should emit a plurality of ultrasonic beams.

Continuingly referring to FIG. 1, the detection system 100 further includes a signal receiving level 120, signal processing level 130 and a back-end image synthesis level 140. The signal receiving level 120 includes a plurality of receiving units 122[0:N], a plurality of amplifiers 124[0:N] and a plurality of analog-digital converters (ADC) 126[0:N]. The plurality of receiving units 122[0:N] can respectively receive the reflected ultrasonic beams in a predetermined range and generate a plurality of channel signals CH[0:N] to the plurality of amplifiers 124[0:N]. Then, the plurality of amplifiers 124[0:N] respectively amplify the received channel signals CH[0:N] and transmit the amplified channel signals CH[0:N] to ADC 126[0:N]. The ADC 126[0:N] convert the amplified channel signals CH[0:N] into a plurality of digital data signals DATA[0:N], and transmit the plurality of digital data signals DATA[0:N] to signal processing level 130.

The signal receiving level 130 includes a plurality of demodulators 132[0:N], a plurality of buffers 134[0:N] and a plurality of devices for time delay and phase rotation 136[0:N] and a processing module 138. The plurality of demodulators 132[0:N] is respectively coupled to the plurality of ADC 126[0:N], so as to receive and demodulate the digital data DATA[0:N], and further generate a plurality of demodulating signals De_MOD [0:N]. The plurality of demodulating signals De_MOD [0:N] is transmit to the plurality of devices for time delay and phase rotation 136[0:N] through the plurality of buffers 134[0:N] for time delaying and phase rotating, and further generating a vector matrix data x(t). Then, the vector matrix data x(t) can be transmit to the processing module 138 to be processed.

Particularly, in the embodiment, when the processing module 138 receives the vector matrix x(t), the processing module 138 is not able to process the correction matrix operation, but adds all vector matrix data x(t) in a predetermined time interval to generate a total vector matrix.

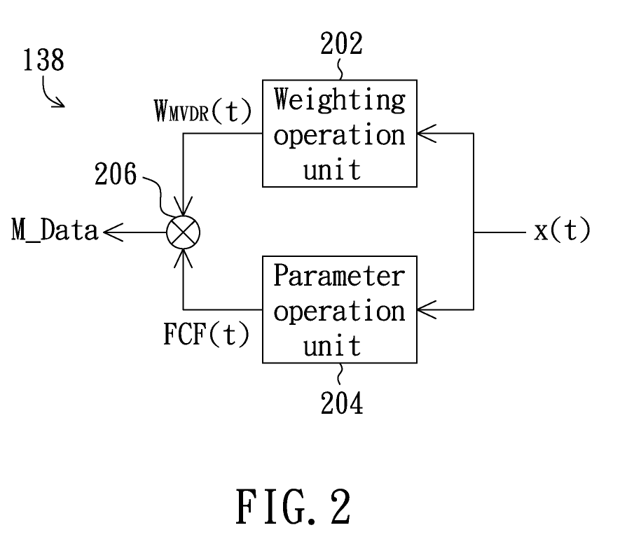

FIG. 2 shows a block diagram of the processing module according to a preferred embodiment of the present invention. Referring to FIG. 2, in the embodiment, the processing module 208 includes a weighting operation unit 202, a parameter operation unit 204 and a multiplier 206. The weighting operation unit 202 is used for receiving the vector matrix data x(t) and summing the vector matrix data x(t) obtained in the predetermined time interval, so as to obtain a total vector matrix y(t), which is presented as:

$$y ( t ) = {\sum }_{i = - K}^{K} x ( t + i )$$

Wherein, K is an integer.

After obtaining the total vector matrix, obtaining a correlation matrix (\hat{R}ₓₓ(t)) through the total vector matrix multiplied by a transposed total vector matrix, above description can be presented by as following function

$${\hat{R}}_{xx} ( t ) = {\sum }_{i = - K}^{K} x ( t + i ) {( {\sum }_{i = - K}^{K} x ( t + i ) )}^{H} + δ I$$

Wherein δ is a constant, and I is a unit matrix.

The weighting operation unit 202 can perform an inversion operation of the correlation matrix \hat{R}ₓₓ(t) according to a follow function:

$${\hat{R}}_{xx}^{- 1} ( t ) = \frac{1}{δ} I - \frac{\frac{1}{{δ}^{2}} y ( t ) {y}^{H} ( t )}{1 + \frac{1}{δ} {y}^{H} ( t ) y ( t )}$$

In right side of an equal mark of this function, a denominator of a second operation unit is a constant, thus, the calculation of total function is simple.

Besides, the weighting operation unit 202 can also be used for calculating a weight value (W_{MVDR}(t) according to the inversion correlation matrix \hat{R}ₓₓ⁻¹(t), which is presented as:

$${W}_{MVDR} ( t ) = \frac{{\hat{R}}_{XX}^{- 1} ( t ) a}{{a}^{H} {\hat{R}}_{XX} ( t ) a}$$

Wherein a is a unit vector.

Referring to FIG. 2 continuingly, in another aspect, the weighting operation unit 204 is also used for receiving the vector matrix data x(t) and obtaining a flexible correction parameter function (FCF(t)) that is presented as:

$$F C R ( t ) = {( \frac{{\sum }_{n = 0}^{N - 1} {x}_{n} ( t )}{\sqrt{N {\sum }_{n = 0}^{N - 1} {\vert {x}_{n} ( t ) \vert}^{2}}} )}^{m}$$

Wherein m is suggested a value greater than 0 and less than or equal to 1.

The output end of the weighting operation unit 202 and the parameter operation unit 204 are coupled to the multiplier 206. Therefore, the multiplier 206 processes a weighting operation through the weight value W_{MVDR}(t) multiplied by the flexible correction parameter function FCF(t), and further, a weighting operation result M_Data is obtained and transmitted to the back-end image synthesis level 140, so as to perform an image synthesis procedure.

The back-end image synthesis level 140 includes a buffer 142, a low-pass filter (LPF) 144 and an image synthesis unit 146. After the weighting operation result M_Date being transmitted to the back-end image synthesis level 140, the weighting operation result M_Date is first received by the buffer 142 and further be output into the LPF 144 for low-pass filtering to filter the noise. The weighting operation result M_Data after low-pass filtering can be transmitted to the image synthesis unit 146. Thus, the image synthesis unit 146 can obtain an image massage IMG in the predetermined range.

As stated above, in the present invention, the processing module firstly sums all the vector matrixes in the predetermined time interval, and further calculates the correction matrix, thus, the operation complexity can be simplified. Besides, an inversion correlation matrix obtained through the manner stated above is relatively simple, thus, the operation complexity of the system can be further simplified.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A detection system, comprising:
an ultrasonic module including a plurality of ultrasonic units arranged in array, and the plurality of ultrasonic units continuously emitting a plurality of ultrasonic beams in a predetermined range;
a plurality of receiving units respectively receiving reflected ultrasonic beams and generating a plurality of channel signals;
a plurality of analog-digital converters respectively converting the channel signals into digital data so as to generate a vector matrix data;
a processing module obtaining a total vector matrix data by summing the vector matrix data received in a predetermined time interval, and further obtains a correction matrix through the total vector matrix data multiplied by the transposed total vector matrix data; the processing module further performing an inversion operation of the correction matrix and obtaining a weight value according to the inversion correction matrix, so that a weighting operation being performed for the vector matrix data in the predetermined time interval according to the weight value, so as to obtain a weighting operation result; and
an image synthesis unit obtaining an image massage according to the weighting operation result.

2. The detection system according to claim 1, wherein the processing module further comprising:
a weighting operation unit used for generating the correction matrix and the weight value;
a parameter operation unit generating a relative parameter function according to the vector matrix data; and
a multiplier coupled to the weighting operation unit and the parameter operation unit, so that the weighting operation of the vector matrix data being performed through the relative parameter function multiplied by the weight value to obtain the weighting operation result.

3. The detection system according to claim 1, further comprising a plurality of amplifiers respectively coupled to the plurality of receiving units, for amplifying the channel signals and transmitting the amplified channel signals to the analog-digital converters.

4. The detection system according to claim 1, further comprising:
a plurality of demodulators respectively coupled to the plurality of analog-digital converters, for demodulating the digital data;
a plurality of first buffers respectively coupled to the plurality of demodulators, for receiving demodulated digital data; and
a plurality of devices for time delay and phase rotation respectively coupled to the plurality of first buffers, for performing time delay and phase rotation for the demodulated digital data, and further generating the vector matrix data.

5. The detection system according to claim 1, further comprising:
a second buffer coupled to the processing module, for receiving the weighting operation value; and
a low-pass filter coupled to the second buffer, for performing a low-pass filtering procedure of the weighting operation value to filter the noise, and transmitting the weighting operation value after low-pass filtering to the image synthesis unit.

6. A signal processing method, adapted for dealing with a plurality of vector matrixes to detect the image of a predetermined range, and the vector matrix data being generated by reflecting a plurality of ultrasonic beams in the predetermined range, the signal processing method comprising:
summing all vector matrix data in a predetermined time interval so as to generate a total correlation matrix;
obtaining a weight value according to an inversion correlation matrix; and
a weighting operation being performed for the vector matrix data in the predetermined time interval according to the weight value, so as to obtain a weighting operation result for performing an image combination procedure.

7. The signal processing method according to claim 6, wherein the step of generating the inversion correction matrix comprising performing the following operation:
$${( y ( t ) {y}^{H} ( t ) + δ I )}^{- 1} = \frac{1}{δ} I - \frac{\frac{1}{{δ}^{2}} y ( t ) {y}^{H} ( t )}{1 + \frac{1}{δ} {y}^{H} ( t ) y ( t )}$$
wherein y(t) is the total vector matrix, δ is a constant, and I is a unit matrix.

8. The signal processing method according to claim 6, wherein the step of generating the weight value comprising performing the following operation:
$$\frac{{\hat{R}}_{XX}^{- 1} ( t ) a}{{a}^{H} {\hat{R}}_{XX} ( t ) a}$$
wherein \hat{R}_{XX}(t) is the correction matrix, and a is a unit matrix.

9. The signal processing method according to claim 6, wherein the step of obtaining the weighting operation result is the weight value multiplied by a flexible parameter function, and the step of obtaining the flexible correction parameter function comprising performing the following operation:
$${( \frac{{\sum }_{n = 0}^{N - 1} {x}_{n} ( t )}{\sqrt{N {\sum }_{n = 0}^{N - 1} {\vert {x}_{n} ( t ) \vert}^{2}}} )}^{m}$$
wherein xn(t) is a vector function corresponding to each of the reflected ultrasonic beams, N is a total number of the ultrasonic beams, and m is a greater than 0 and less than or equal to 1.
